(19) United States
(12) Patent Application Publication
(10) Pub. No.: US 2014/0156384 A1
(43) Pub. Date: Jun. 5, 2014

(54) ELECTRONIC DEVICE AND DATA ANALYZING METHOD

(71) Applicant: HON HAI PRECISION INDUSTRY CO., LTD., New Taipei (TW)

(72) Inventors: CHUNG-I LEE, New Taipei (TW); CHIU-HUA LU, New Taipei (TW); LEE-FAN CHANG, New Taipei (TW); CHIEN-CHIH LIN, New Taipei (TW); YU-CHUN LIN, New Taipei (TW); TSUNG-HSIN YEN, New Taipei (TW)

(73) Assignee: HON HAI PRECISION INDUSTRY CO., LTD., New Taipei (TW)

(21) Appl. No.: 14/092,947

(22) Filed: Nov. 28, 2013

(30) Foreign Application Priority Data
Dec. 5, 2012 (TW) 101145554

(51) Int. Cl. G06Q 30/02

(52) U.S. Cl. CPC G06Q 30/0246; G06Q 30/0244
USPC 705/14.43; 705/14.45

(57) ABSTRACT

In a method for analyzing play results of advertisements in client computers using a server, the method receives play results of played advertisements in the client devices, collects total play results of the played advertisements in the client devices after a preset interval, and determines whether an unqualified advertisement whose play results do not match preset requirements is found in the server. The method further determines an updated advertisement played in the client devices when the unqualified advertisement has been found, and sends the updated advertisement to each of the client devices.

### BACKGROUND

1. Technical Field

Embodiments of the present disclosure relate to cloud computing technology, and particularly to an electronic device and a data analyzing method using the electronic device.

2. Description of Related Art

Advertisements can be embedded in an application program (e.g., an electronic book) of an electronic device (e.g., a computer). When the application program is invoked, the advertisements are played. However, the same advertisements are played when the application program is invoked. The advertisements played are not updated according to actual play results (e.g., a play frequency) of the advertisements played. Therefore, a more efficient method for analyzing play results of the advertisements is desired.

### BRIEF DESCRIPTION OF THE DRAWINGS

FIG. 1 is a block diagram of a plurality of servers connecting with a plurality of client computers.

FIG. 2 is a block diagram of one embodiment of a client computer including a data analyzing client system.

FIG. 3 is a block diagram of one embodiment of the server including a data analyzing server system.

FIG. 4 is a block diagram of function modules of the data analyzing client system included in the client computer.

FIG. 5 is a block diagram of function modules of the data analyzing server system included in the server.

FIG. 6 is a flowchart of one embodiment of a method for analyzing play results of advertisements in the client computers.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive, or other storage medium.

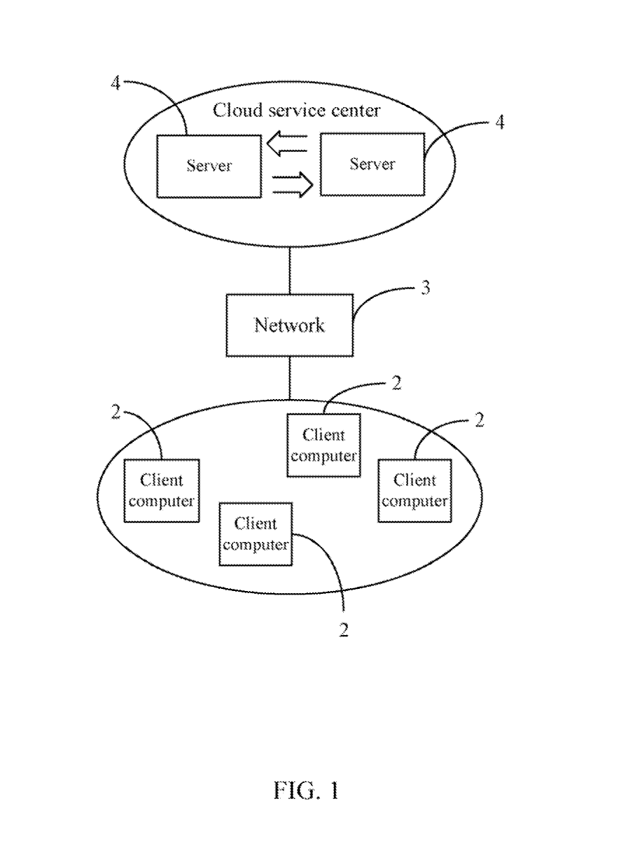

FIG. 1 is a schematic diagram of a plurality of servers 4 connected to a plurality of client computers 2. In one embodiment, the servers 4 are connected to the client computers 2 through a network 3. The network 3 may be an intranet, the Internet or other suitable communication network, such as general packet radio service (GPRS), WIFI/wireless local area network (WIFI/WLAN), third generation/wideband code division multiple access (3G/WCDMA), or 3.5G/high-speed downlink packet access (3.5G/HSDPA). In one embodiment, a data analyzing client system 24 is installed in each client computer 2, and a data analyzing server system 44 is installed in each server 4.

The plurality of servers 4 include a cloud service center, one of the servers 4 is assigned as a master server, and the residual servers 4 are slave servers. The master server and the slave servers may be changed according to loads of the servers. For example, if the load of the master server is greater than a preset threshold, an updated master server which has a lower load is selected from the slave servers. In other embodiments, the cloud service center can include one master server.

Each client computer 2 can download an application program (e.g., an electronic book) from the servers 4 through the network 3. Specified content (e.g., advertisements) can be embedded in the application program, and played when the application program is invoked in the client computer 2. In this embodiment, the specified content is illustrated as the advertisements. It should be noted that the specified content is not limited to the advertisements. In other embodiments, the specified content may be other information, such as English study data.

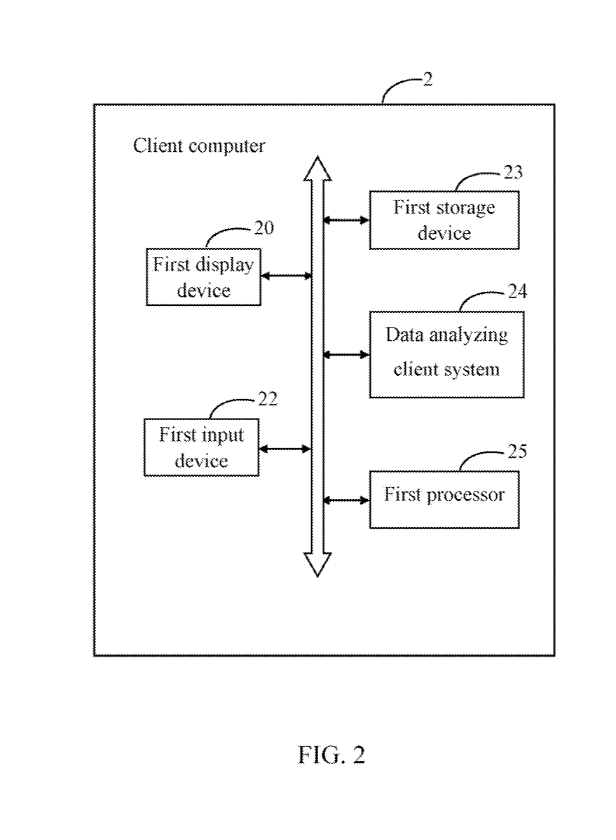

FIG. 2 is a block diagram of one embodiment of an client computer 2 including the data analyzing client system 24. In one embodiment, the client computer 2 further includes a first display device 20, a first input device 22, a first storage device 23, and a first processor 25. FIG. 2 illustrates only one example of the client computer 2 that can include more or fewer components than illustrated, or have a different configuration of the various components in other embodiments. The client computer 2 can be a desktop computer, a mobile phone, a personal digital assistant (PDA), or other suitable electronic devices.

The first display device 20 displays the advertisements embedded in the application program, and the first input device 22 can be a mouse or a keyboard for data input. The first storage device 23 can be a non-volatile computer storage chip which can be electrically erased and reprogrammed, such as a hard disk or a flash memory card.

In one embodiment, the data analyzing client system 24 is used to collect play results (e.g., a play frequency) of a played advertisement in the client computer 2, send the play results of the played advertisement to a specified server 4 (e.g., the master server), receive an updated advertisement determined by the specified server 4 according to the play results of the played advertisement in each client computer 2, and display the updated advertisement on the first display device 20, so that the advertisement played in the client computer 2 is updated according to actual play results of the advertisement. The data analyzing client system 24 can include computerized instructions in the form of one or more programs executed by the first processor 25 and stored in the first storage device 23 (or memory).

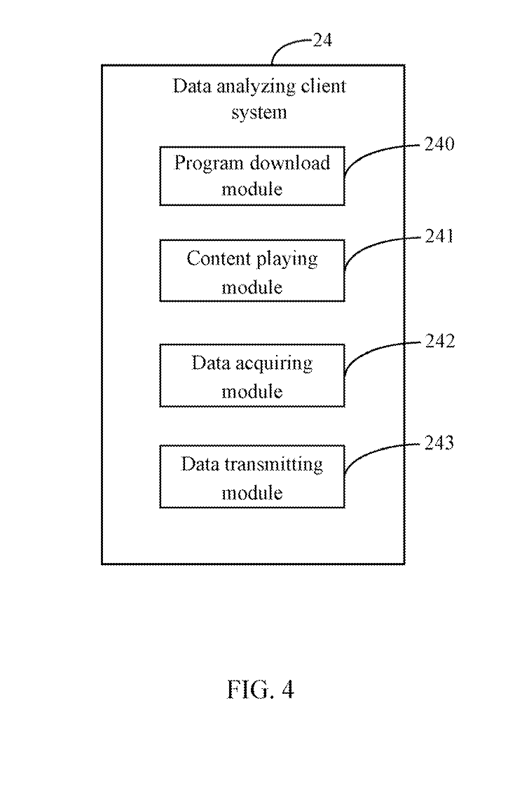

FIG. 4 is a block diagram of function modules of the data analyzing client system 24 included in the client computer 2. In one embodiment, the data analyzing client system 24 can include one or more modules, such as a program download module 240, a content playing module 241, a data acquiring module 242, and a data transmitting module 243. In general, the word “module,” as used herein, refers to logic embodied in hardware or firmware, or to a collection of software instructions written in a programming language. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable medium include flash memory and hard disk drives.

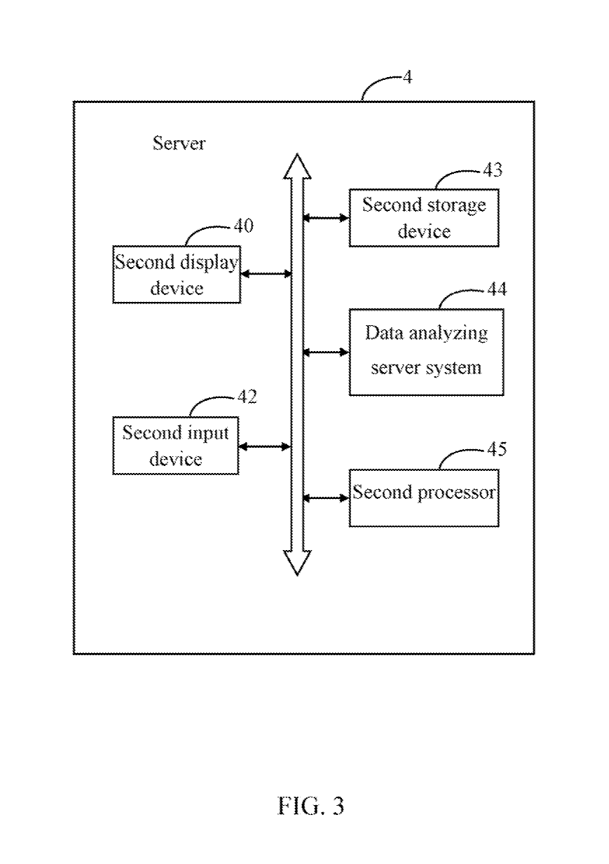

FIG. 3 is a block diagram of one embodiment of the server 4 including the data analyzing server system 24. In one embodiment, the server 4 further includes a second display device 40, a second input device 42, a second storage device 43, and a second processor 45. FIG. 3 illustrates only one example of the server 4 that can include more or less components than illustrated, or have a different configuration of the various components in other embodiments. The second display device 40 and the second input device 22 are input/output devices of the server 4.

In one embodiment, the data analyzing server system 44 is used to receive the play results of the played advertisement in each client computer 2, determine an updated advertisement according to the play results of the played advertisement in each client computer 2, and send the updated advertisement to each client computer 2, so that the advertisement played in the client computer 2 is updated according to the actual play results of the advertisement. The data analyzing server system 44 can include computerized instructions in the form of one or more programs that are executed by the second processor 45 and stored in the second storage device 43 (or memory).

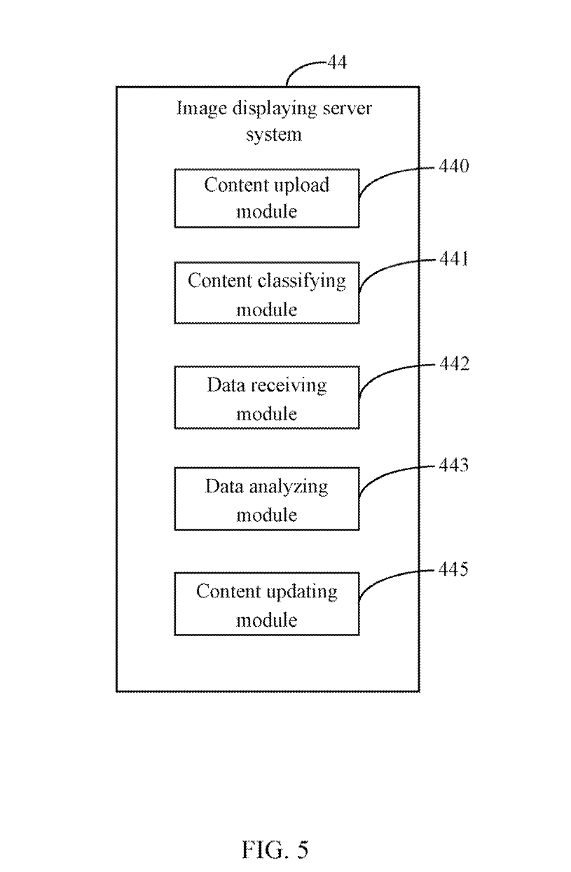

FIG. 5 is a block diagram of function modules of the data analyzing server system 44 included in the server 4. In one embodiment, the data analyzing server system 44 can include one or more modules, such as a content upload module 440, a content classifying module 441, a data receiving module 442, a data analyzing module 443, and a content updating module 445.

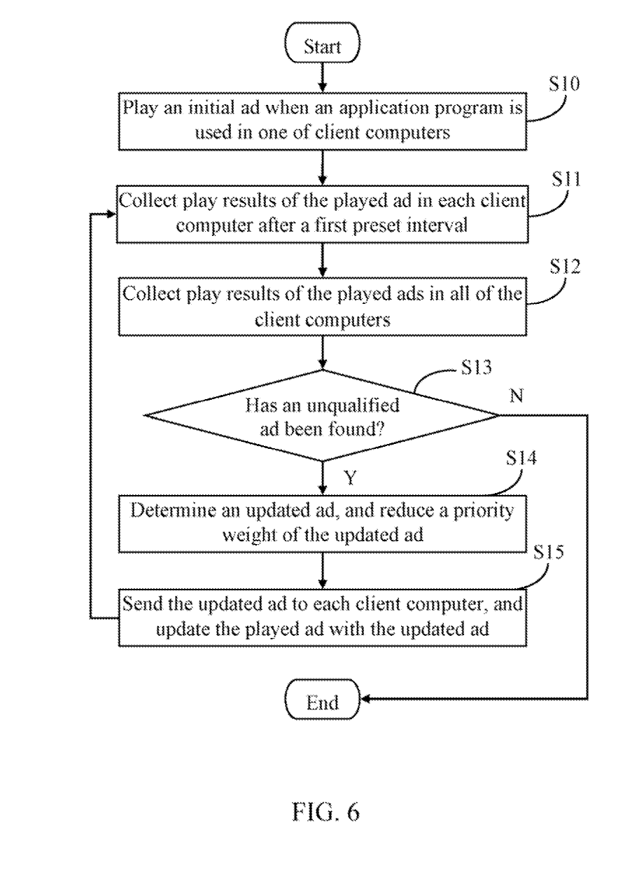

FIG. 6 is a flowchart of one embodiment of a method for analyzing play results of advertisements in the client computers. Depending on the embodiment, additional steps may be added, others removed, and the ordering of the steps may be changed.

Before analyzing the play results of the advertisements in the client computers, advertisements are uploaded to a specified server 4 (e.g., the master server) first. When an advertiser wants to add an advertisement to the client computers 2, an administrator may add the advertisement in a specified application program, and upload the specified application program in the specified server 4 through the content upload module 440. Preset requirements of the play results of the advertisement may be predetermined by the advertiser. For example, the preset requirements can include a preset click frequency of click events of the advertisement (how many times the advertisement needs to be clicked or played, or called as “play frequency”), a preset reading time of each click event of the advertisement (a duration between a start time of the advertisement and a close time of the advertisement), and a preset number of users who watch the advertisement.

For example, the click frequency is 10000, and the reading time of each click event is ten seconds. In one embodiment, if the play results of one advertisement match the preset requirements, the specified server 4 stops playing the advertisement in the client computers 2, and selects an updated advertisement whose play results do not match the preset requirement, so that the advertisements played in the client computers 2 are updated dynamically.

In one embodiment, the advertisement are preset to be in different levels according to different levels of the advertisers. A priority weight is set for each advertisement to determine a play priority of each advertisement. The advertisement having the highest priority weight is played first.

When the uploaded advertisements are received by the content upload module 440, the content classifying module 441 divides the uploaded advertisements into different types of content. In one embodiment, the uploaded advertisements are divided into three types of content, such as audio content, video content, and image content. An advertisement can include two or three types of content such as audio content and video content.

In one embodiment, the different types of content of the uploaded advertisements are encoded using different coding algorithms. The encoded content of the uploaded advertisements are stored in the second storage device 43 of the specified server 4, so that storage spaces of the second storage device 43 are reduced and transmission loads of the uploaded advertisements transmitted to the client computers 2 are also reduced.

For example, the audio content is encoded using an adaptive differential pulse code modulation (ADPCM) algorithm, the video content is encoded using the H.264 coding algorithm, and the image content is encoded using the tagged image file format (TIFF) coding algorithm. The encoded content is embedded in the specified application program (e.g., an electronic book). When the specified application program is downloaded by one of the client computers 2 through the program download module 240, the encoded content of the advertisements are transmitted to the client computer 2 with the specified application program at the same time.

In step S10, when the specified application program is invoked in one of the client computers 2, the content playing module 241 plays an initial advertisement embedded in the specified application program. In this embodiment, the specified application program embeds one initial advertisement. In other embodiments, a plurality of initial advertisements can be embedded in the specified application program.

In step S11, the data acquiring module 242 collects play results of the advertisement being played (hereinafter referred to as “played advertisement”) in the client computer 2 after a first preset interval (e.g., ten minutes), and stores the play results of the played advertisement in the first storage device 23.

The play results of the played advertisement can include an actual click frequency of click events of the played advertisement (how many times the played advertisement is actually clicked or played), an actual reading time of each click event of the played advertisement (a duration between a start time of the played advertisement and an end time of the played advertisement), and an actual number of users who watch the played advertisement. The actual number of users who watch the played advertisement can be determined by the frequency of using the specified application program (how many times the specified application program is invoked).

When a collection time of the play results of the played advertisement reaches a preset cycle time (e.g., one hour), the data transmitting module 243 transmits total play results of the played advertisement within the preset cycle time to a specified server 4 (e.g., the nearest server close to client computer), and deletes the play results of the played advertisement within the preset cycle time from the first storage device 23, to free up the storage space of the first storage device 23.

If the collection time of the play results of the played advertisement does not reach the preset cycle time, the data transmitting module 243 does not transmit the play results of the played advertisement to the specified server 4, to reduce the data transmission frequency between the client computer 2 and the specified server 4.

In step S12, the data receiving module 442 of the specified server 4 receives the play results of the played advertisement sent from the client computer 2. The data analyzing module 443 of the master server 4 collects the play results of the played advertisements in all of the client computers 2 after a second preset interval (e.g., two hours). In one embodiment, the master server 4 collects the play results of the played advertisements received by all of the servers 4 in the cloud service center.

In one embodiment, the advertisement played in each client computer 2 can be different. For example, a first client computer “C1” installs a first application program “App1” embedded with a first advertisement “Ad1,” a second client computer “C2” installs a second application program “App2” embedded with a second advertisement “Ad2,” and a third client computer “C3” installs a third application program “App3” embedded with a third advertisement “Ad3.” The first client computer “C1” sends the play results of the first advertisement “Ad1” to a first server “S1,” the second client computer “C2” sends the play results of the second advertisement “Ad2” to a second server “S2,” and the third client computer “C3” sends the play results of the third advertisement “Ad3” to a third server “S3.” If that the second server “S2” is the master server in the cloud service center, the second server “S2” collects the play results of the three advertisements “Ad1,” “Ad2,” and “Ad3,” from the first server “S1” and the third server “S3” after the second preset interval.

In step S13, the data analyzing module 443 determines an unqualified advertisement whose play results do not match the preset requirements according to the play results of all the played advertisements, and determines whether the unqualified advertisement has been found in the master server. The unqualified advertisement may include the advertisement which is not played (non-played advertisement), and the advertisement which is played but the play results of the played advertisement do not match the preset requirements (unqualified played advertisement). If the unqualified advertisement has been found, the procedure goes to step S14. If the unqualified advertisement has not been found, the procedure ends.

For an illustrated description of step S13, the actual click frequency of the click events of the played advertisement and the actual reading time of each click event of the played advertisement are invoked to determine whether the unqualified advertisement has been found. If the actual click frequency of the click events of a played advertisement is greater than the preset click frequency (e.g., 10000), and the actual reading time of each click event of the played advertisement is greater than the preset reading time (e.g., ten seconds), the data analyzing module 443 determines that the play results of the played advertisement match the preset requirements. In one embodiment, if an actual reading time of a click event is greater than the preset reading time, the click event is determined as a valid click event, which represents the advertisement of user's interest. That is, if a number of the valid click event of the played advertisement is greater than the preset click frequency, the data analyzing module 443 determines that the play results of the played advertisement match the preset requirements (qualified advertisement). If the number of the valid click event of the played advertisement is less than or equal to the preset click frequency, the data analyzing module 443 determines that the play results of the played advertisement do not match the preset requirements (unqualified advertisement).

In one embodiment, the data analyzing module 443 may determine an optimized type of the advertisement for the specified application program invoked in the client computers 2 according to the time spent matching the preset requirements of each advertisement. The time spent represents time how long the play results of the advertisement match the preset requirements. The optimized type of the advertisement is the type which has a shortest time to match the preset requirements. For example, if the type of the image content of the advertisement has the shortest time to match the preset requirements in the electronic book of the client computers 2, the data analyzing module 443 determines that the optimized type of the advertisement for the electronic book is the image type. In other embodiments, the optimized type of the advertisement may be the type of the advertisement which has a longest actual reading time.

In step S14, the content updating module 445 determines an updated advertisement played in the client computer 2, and reduces a priority weight of the updated advertisement. In one embodiment, if the play results of one advertisement match the preset requirements, the content updating module 445 sets the priority weight of the advertisement as a lowest value (e.g., zero), or stops playing the advertisement in the client computers 2 until the advertiser makes a renewal. In one embodiment, the content updating module 445 determines the updated advertisement by selecting unqualified advertisements whose play results do not match the preset requirements from all of the advertisements in the servers 4, and determining the updated advertisement as a specified advertisement which has a highest priority weight from the unqualified advertisements.

If the play results of an advertisement do not match the preset requirements within a preset time length, the content updating module 445 increases the priority weight of the advertisement. For example, if the advertisement is not played within a first preset time length (e.g., fourteen days), the content updating module 445 increases the priority weight of the advertisement by a first value. If the advertisement is played but the play results of the advertisement do not match the preset requirements within a second preset time length (e.g., seven days), the content updating module 445 increases the priority weight of the advertisement by a second value. In one embodiment, the first value is greater than the second value, so that the advertisement which is not played has a higher priority weight to play first. In other embodiments, the first preset time length can be equal to the second preset time length.

In step S15, the content updating module 445 sends the updated advertisement to each client computer 2, plays the updated advertisement in each client computer 2, and the procedure returns to step S11. In one embodiment, the content of the advertisements is encoded using different coding algorithms according to the types of content. The content updating module 445 sends an encoded package of the updated advertisement to each client computer 2. When the client computer 2 receives the encoded package of the updated advertisement, the content playing module 241 decodes the updated advertisement, and plays the updated advertisement on the first display device 20 of the client computer 2. In other embodiments, the content of the updated advertisement may be directly transmitted to each client computer 2 without encoding.

In still other embodiments, when the specified application program is invoked in the client computer 2, the content playing module 241 obtains advertisements whose play results do not match the preset requirements from the plurality of servers 4, selects an advertisement which has a highest priority weight from the obtained advertisements, and plays the selected advertisement on the first display device 20, or selects a plurality of advertisements which have higher priority weight from the obtained advertisements, and plays the selected advertisements on the first display device 20.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for analyzing play results of advertisements in a client device, the method comprising:
playing an initial advertisement embedded in a specified application program of the client device when the specified application program is invoked in the client device;
collecting play results of the played advertisement after a first preset interval, and storing the play results of the played advertisement in a storage device of the client device;
transmitting total play results of the played advertisement within a preset cycle time to a server when a collection time of the play results of the played advertisement reaches the preset cycle time; and
receiving an updated advertisement from the server, and playing the updated advertisement on a display device of the client device.

2. The method according to claim 1, wherein the play results of the played advertisement comprise an actual click frequency of click events of the played advertisement, and an actual reading time of each click event of the played advertisement.

3. The method according to claim 2, wherein the updated advertisement is determined as a specified advertisement which has a highest priority weight and the play results of the specified advertisement do not match preset requirements.

4. The method according to claim 1, further comprising: decoding content of the updated advertisement, and playing a decoded advertisement on the display device of the client device.

5. The method according to claim 1, further comprising:
obtaining advertisements whose play results do not match the preset requirements from the server when the specified application program is invoked in the client device; and
selecting a specified advertisement which has a highest priority weight from the obtained advertisements, and playing the selected advertisement on the display device of the client device.

6. A method for analyzing play results of advertisements in a plurality of client devices using a server, the method comprising:
receiving play results of played advertisements in the client devices, and collecting total play results of the played advertisements in the client devices after a second preset interval;
determining whether an unqualified advertisement whose play results do not match preset requirements is found in the server;
determining an updated advertisement played in the client devices when the unqualified advertisement has been found, and reducing a priority weight of the updated advertisement; and
sending the updated advertisement to each of the client devices.

7. The method according to claim 6, wherein the play results of the played advertisement comprise an actual click frequency of click events of the played advertisement, and an actual reading time of each click event of the played advertisement.

8. The method according to claim 7, wherein the updated advertisement is determined as a specified advertisement which has a highest priority weight and the play results of the specified advertisement do not match preset requirements.

9. The method according to claim 8, further comprising:
determining that the play results of the played advertisement match the preset requirements when a number of a valid click event of the played advertisement is greater than a preset click frequency, an actual reading time of the valid click event being greater than a preset reading time; and
determining that the play results of the played advertisement do not match the preset requirements when the number of the valid click event of the played advertisement is less than or equal to the preset click frequency.

10. The method according to claim 7, further comprising: determining an optimized type of the advertisement for the specified application program invoked in the client devices according to the time spent matching the preset requirements of each advertisement in the server.

11. The method according to claim 10, wherein the optimized type of the advertisement is a type of the advertisement which has a shortest time to match the preset requirements, or a type of the advertisement which has a longest actual reading time.

12. The method according to claim 6, further comprising:
setting a priority weight of an advertisement as a lowest value when the play results of the advertisement match the preset requirements; and
increasing the priority weight of the advertisement when the play results of the advertisement do not match the preset requirements within a preset time length.

13. The method according to claim 12, further comprising:
increasing the priority weight of the advertisement by a first value when the advertisement is not played within a first preset time length; and
increasing the priority weight of the advertisement by a second value when the advertisement is played but the play results of the advertisement do not match the preset requirements within a second preset time length, the first value being greater than the second value.

14. The method according to claim 6, wherein the advertisements in the server are encoded using corresponding coding algorithms according to types of content of the advertisements, the types of the content of the advertisements comprise an audio type, a video type, and an image type.

15. A server, comprising:
a processor;
a storage device storing a plurality of instructions, which when executed by the processor, causes the processor to:
receive play results of played advertisements in a plurality of client devices, and collecting total play results of the played advertisements in the client devices after a second preset interval;
determining whether an unqualified advertisement whose play results do not match preset requirements is found in the server;
determining an updated advertisement played in the client devices when the unqualified advertisement has been found, and reducing a priority weight of the updated advertisement; and
sending the updated advertisement to each of the client devices.

16. The server according to claim 15, wherein the play results of the played advertisement comprise an actual click frequency of click events of the played advertisement, and an actual reading time of each click event of the played advertisement.

17. The server according to claim 16, wherein the updated advertisement is determined as a specified advertisement which has a highest priority weight and the play results of the specified advertisement do not match preset requirements.

18. The server according to claim 17, wherein the plurality of instructions further comprise:
determining that the play results of the played advertisement match the preset requirements when a number of a valid click event of the played advertisement is greater than a preset click frequency, an actual reading time of the valid click event being greater than a preset reading time; and
determining that the play results of the played advertisement do not match the preset requirements when the number of the valid click event of the played advertisement is less than or equal to the preset click frequency.

19. The server according to claim 16, wherein the plurality of instructions further comprise: determining an optimized type of the advertisement for the specified application program invoked in the client devices according to the time spent matching the preset requirements of each advertisement in the server.

20. The server according to claim 19, wherein the optimized type of the advertisement is a type of the advertisement which has a shortest time to match the preset requirements, or a type of the advertisement which has a longest actual reading time.
